(19) United States
(12) Patent Application Publication
(10) Pub. No.: US 2012/0066836 A1
(43) Pub. Date: Mar. 22, 2012

(54) Foldable stretcher and system for transporting a patient on said stretcher

(76) Inventors: Olav Kaarstein, Tolsvsrod (NO); Per Morten Lyngaas, Tonsberg (NO)

(21) Appl. No.: 12/886,775

(22) Filed: Sep. 21, 2010

(51) Int. Cl. A61G 1/013; A61G 1/06

(52) U.S. Cl. 5/627

(57) ABSTRACT

A foldable stretcher for transporting a patient, which stretcher is foldable in both longitudinal and lateral direction. The stretcher has two longitudinal support rods with end pieces at each end, wherein the support rods consist of a number of longitudinal support segments individually linked by hinges. The hinges are foldable substantially in the lateral direction of the stretcher when unfolded. The stretcher has one or more foldable lateral locking devices between the longitudinal supports, which lateral locking devices when extended, spread the longitudinal supports to each side. The lateral locking devices each have two or more lateral locking device rods each linked to the respective longitudinal support rod by hinges and interlinked by a hinge. The lateral locking devices are foldable in the longitudinal direction of the unfolded stretcher.

### FIELD OF THE INVENTION

The present invention pertain to a foldable stretcher, and a system for transporting a patient on said stretcher.

### BACKGROUND OF THE INVENTION

Stretchers of different types have been used in evacuation and transport of patients by air/sea/land to the extent that it has been allowed by regulatory governments. This especially applies for transport of a patient in a vehicle or airplane.

Furthermore, stretchers come in various shapes and sizes, all more or less suited for transport by vessels and airplanes in addition to the manual transport or evacuation from the actual accident site. E.g. transport by ambulance requires the transfer of the patient from the evacuation stretcher to a particularly suited transport stretcher approved for use in ambulances. Regulatory demands in this area have been brought forward by increasing demand for safety both for patients and ambulance personnel. Following accidents where stretchers with patients have moved like lethal flying objects inside an ambulance, the regulatory demands have made a clear distinction between stretchers for evacuation and stretchers for transport in ambulances.

When it comes to transporting patients in airplanes, the regulatory demands are even more complicated as the transporting means for the patient must withstand severe G-forces and radical maneuvers without hazard to neither the patient nor the personnel surrounding the patient, nor to the airplane itself.

As a result of this, separate transporting systems have been developed in order to meet the regulatory demands of the various transporting means, and they have in common the fact that they encompass a stretcher for securing the patient specially suited to that particular transport situation. Furthermore, the ability of the stretcher to take up the load of the passenger during transport is highly variable. Some systems simply use the stretcher as a surface upon which the patient is lying and other stretchers take more or less the weight of the patient and is able to partly restrain the patient and secure the patient during transport. However in all systems there is an interdependent relationship between the stretcher and the support system for the stretcher regarding the load carrying capacity and securing of the patient, enabling the secure transport of the patient.

In general one may further say that when the stretcher support carries 100% of the load exerted by the patient in either direction, then the stretcher does not carry the patient and is thus only a place where the patient is placed. Likewise if the stretcher takes up 100% of the load exerted by the patient in all directions, then the support only have to restrain the stretcher to secure the patient.

In construction of a stretcher and a system for transporting a patient on a stretcher, there is a big difference between restraining a patient in all directions and the similar restraining of the stretcher on its support.

Furthermore, the restraining of a stretcher in different types of vehicles and airplanes with different regulatory demands requires a uniform and compatible stretcher support system both in size and in load carrying capacity and a stretcher compatible with said system.

The obvious benefit of a stretcher being able to fully restrain a patient and take up the full load exerted by the patient in all directions during transport, is that this stretcher may be moved from one transport system to another without having to remove the patient from the stretcher. The components supporting the stretcher during the transport, i.e. the transport system may then only restrain the stretcher (with the patient), rather than actually restrain the patient.

Such a stretcher would together with the transport system have to comply with the regulatory demands for transporting a patient in the various transporting means such as vehicles and airplanes.

It is previously known to have foldable stretchers as such in various forms. However when in use, these stretchers exhibit various load carrying capability and it is to the applicants knowledge no existing solution for a stretcher being foldable in the longitudinal and lateral direction and still being able to fully support not only the weight but also the load exerted by the patient in other directions during transport when the stretcher us fully extended from its folded position. Furthermore, a stretcher with load carrying capacity being able to restrain the patient in all directions is previously found in specialized equipment for ambulances etc., however such stretchers are either not foldable in the longitudinal and lateral direction or they do not fully support the load exerted by the patient in various directions during transport. The latter case is remedied by a support system in the transport vehicle being able to further restrain and support the patient during transport. Finally there are transport equipment and transport systems for patients in vehicles such as ambulances and airplanes being able to fully support the patient, however these systems have separate stretchers or beds rendering it necessary to move the patient from the stretcher on which the patient arrived to the transport means.

### SUMMARY OF THE INVENTION

According to one aspect of the present invention is provided a foldable stretcher for transporting a patient, which stretcher is foldable in both longitudinal and lateral direction. The stretcher consists essentially of two longitudinal support rods with end pieces at each end, wherein the support rods consist of a number of longitudinal support segments individually linked by hinges. The hinges are foldable substantially in the lateral direction of the stretcher when unfolded. The stretcher comprises one or more foldable lateral locking devices between the longitudinal supports, which lateral locking devices when extended, spread the longitudinal supports to each side. The lateral locking devices each consist of two or more lateral locking device rods each linked to the respective longitudinal support rod by hinges and interlinked by a hinge. The lateral locking devices are foldable in the longitudinal direction of the unfolded stretcher. The stretcher furthermore comprise a canvas upon which the patient will rest, which canvas has open channels in the longitudinal direction in which the longitudinal supports are extending. The canvas is fitted with attachments means for firmly attaching the canvas to each of the outermost longitudinal support segments of the longitudinal support rods, which outermost segments of the longitudinal support rods are fitted with attachment means for firmly attaching to the attachments means of the canvas. The stretcher is further fitted with a harness, which harness is attached to the canvas in the shoulder area of the patient placed on the stretcher, and which harness is attached to the canvas in the groin area of a patient placed on the stretcher. The harness is attached to the canvas on each side of the stretcher close to the longitudinal support rods, and the harness has adjustable harness elements underneath the canvas, attached to the harness, which adjustable harness elements are connected to the lateral locking devices when the stretcher is unfolded.

The foldable stretcher according to the invention has an advantageous construction for use in a system for transporting a patient without having to move the patient from the stretcher, enabling the transport of the patient on the same stretcher from the accident site to the end treatment facility.

One of the features of the stretcher is its load carrying capability and the capability of securing the patient during transport. The stretcher, although foldable and lightweight, is, due to its construction, able to fully secure a patient during transport and has a full load carrying capability regardless of transporting means. Resulting from this the patient can remain secured to the stretcher during parts of or the entire transport and the same stretcher will be secured to the transporting means using the system for transporting a patient in accordance with the present invention.

This enables the transport of a patient from the accident site to the end treatment facility without the need for transferring the patient to other carrier means such as other stretchers. This applies to transport in vehicles such as boats and land vehicles and furthermore also to airplanes in addition to the ordinary manual transport of a patient on a stretcher. The benefits to the patient are several and will be discussed further below. The benefits to the personnel involved in transporting the patient are also substantial. Finally the equipment and system used in transporting the patient, especially in vehicles and airplanes, will be substantially reduced in complexity, cost and the need for approval by relevant authorities, provided that the stretcher is approved for such transport. In essence the stretcher plays a larger role in the approval of the system.

When the stretcher is used for transporting a patient, the patient may be safely placed on the stretcher according to the present invention and may thus remain secured to the same stretcher during the entire transport. This applies for the transport from the accident site, whether this is the site for a civilian casualty e.g. a car accident, or a military type injury e.g. a shrapnel or projectile injury in the combat theatre, and all the way to the end treatment facility. The patient may of course be removed from the stretcher during this transport if medical or other considerations are in favor this. However the stretcher according to the present invention has the capability of a continuous transport.

The foldable properties of the stretcher also enable the stretcher to be well suited for easy transport into the field, e.g. for military use in medical evacuation or similar situations. When folded the stretcher is easy to handle and may easily be stored in a vehicle or in a backpack for emergency use.

The present invention, in one aspect, thus pertain to a stretcher suited for transporting a patient and a system for transporting the patient on said stretcher, where the stretcher has the load carrying capacity of adequately restraining the patient during transport and the load carrying components of the transport system has the load carrying capacity of adequately restraining the stretcher during transport. Furthermore this applies to transport in various ways, in various vehicles such as boats and land vehicles, and also airplanes.

Even further, the stretcher is of such a design and construction that it is foldable for easy transport into the accident area. The solution for folding the stretcher must thus be of such nature that the stretcher may provide full load carrying capacity in all directions when the stretcher is unfolded, and yet being able to be folded for separate transport to the patient in the field, e.g. during medical evacuation during military combat.

When the patient is placed on a stretcher according to the present invention, the patient may be secured to the stretcher in such a way that the patient is ready for transport without further securing of the patient in the transport vessel beyond the simple securing of the stretcher. I.e. the stretcher is inherently carrying the load of the passenger in al directions during transport, whether this is simply supporting the weight of the patient or withstanding G-forces in either as stated in the regulatory demands for such securing of patients during transport.

The patient may then remain on the same stretcher during the transport all the way from the accident site through to the final destination for treatment. This relieves the patient of the stress involved in moving the patient from one stretcher to another. The benefits of this are not much disputed for several medical reasons, e.g. because the patient is less likely to experience additional pain and damage during the shift from one stretcher to another and the amount of pain-relieving and tranquillizing medication is reduced, again reducing the stress on the patients body.

Thus, the solution of enabling the transport of a patient on a single stretcher all the way from the accident site to the final destination is dependent on two issues:
The stretcher must be able to fully support the patient according to all regulatory demands during the entire chain of transport.
The equipment and system for transporting the stretcher in each transporting means must be able to fully support the same stretcher with the patient in all parts of the chain of transport.

This reflects on both the ability of the stretcher to simply physically fit into the transport system and the ability of the stretcher to support the load of the patient in all directions during transport and finally the ability of the stretcher to be restrained in the transport means during transport and conveying the load exerted by the patient in all directions to the support for the stretcher.

Furthermore this reflects on the supporting equipment and system for transporting the patient on the stretcher, in the sense that it must be able to receive the load exerted on the stretcher and furthermore support the stretcher in all directions necessary to comply with the regulatory demands.

Finally if the stretcher is foldable it must be able to be unfolded to a construction encompassing the above features and characteristics.

Based on the above described motivation and prior art the following inventive foldable stretcher for transporting a patient and system for transporting a patient on said stretcher is described.

The Foldable Stretcher

In one aspect of the invention the stretcher essentially comprises a longitudinal support rod on each side of the stretcher, which support rods spread a canvas upon which the patient is to be placed.

The Support Rods and Hinges

The rods however comprise a number of longitudinal support members linked by hinges. Thus the longitudinal support rods may be folded at the hinges to fold the stretcher.

Each hinge comprises two separate hinge elements, forming the end piece of the individual longitudinal support members, which hinge elements revolves around a common pin, enabling the hinges to fold the longitudinal support rods in the lateral direction of the stretcher when unfolded. Additionally the hinges fold in different directions along the lateral plane of the stretcher when the stretcher is folded. This ensures that the hinges do not accidently collapse or fold during use of the stretcher due to the weight of the patient. Neither will the stretcher be prone to loose its shape when placed on uneven ground.

When the stretcher is to be folded, the longitudinal support rods are simply rotated 90° towards each other along the longitudinal axes and then folded using the hinges.

The hinges according to one aspect are comprised of two 90° arc shaped hinge elements each comprising a number of discs individually spaced apart. The discs extend in the lateral direction of the stretcher when unfolded and thus enable the hinge to carry a substantial load when a patient is placed on the canvas of the stretcher. The spacing between the disks has substantially the same dimension as the thickness of the disks on the opposite hinge elements thus enabling the disks on each hinge elements to mesh. The hinge elements revolve on a common pin perpendicular to the disks and the arch shaped disks thus form a hinge. Furthermore the pin around which the hinge elements revolve is placed to one side of the disks, forming an ex-center point of rotation. This, in combination with the 90° arc shaped form of the elements enable the hinges to self-lock when the stretcher is unfolded.

The hinges can further be fitted with a groove or hole extending entirely through or partly through the individual hinge elements enabling a lock pin to be inserted through the hinge elements to ensure that they do not accidently open. The groove or hole will typically be placed in the same direction as the pin about which the hinge elements revolve, at a distance from the pin about which the hinge elements revolve. The hole in the centre of the hinge may additionally be used for attaching a harness used by personnel carrying the stretcher or as a support for iv-poles.

In the preferred embodiment the longitudinal support rods each consists of four support rod members interconnected by three hinges. The outermost hinges fold the same way, i.e. the ex-center pin connection of the hinge elements is placed on the same side of the hinge. The hinge connecting the two middle support rod elements has the ex-center pin connection on the opposite side, enabling these support rod elements to be folded in the opposite direction. This configuration of the hinges enables the longitudinal support rods of the stretcher to be folded into ¼ of the total length. Also the hinges fold in different directions, enabling the stretcher to be folded into one collapsed unit with the handles facing in the same direction. This renders it easy to take hold of the collapsed stretcher for use when the stretcher is placed in a container or back pack.

Due to the arc shaped form of the hinge elements, the hinges are also pinch free, i.e. they cannot pinch a user or patient, as the arc shaped elements will gradually push away any element in contact when the hinges are extended or collapsed.

The End Pieces of the Longitudinal Support Rods

At each end of the longitudinal support rods there is a handle to make sure that the user can get a firm grip of the stretcher, especially when carrying a patient. In order to make sure the stretcher will fit into the various vehicles and airplanes, and to comply with the demands of ruling standards, these handles can be extended from and inserted into the longitudinal rods.

In the preferred embodiment the end pieces are furthermore fitted with a locking device enabling the end pieces to be locked the extended position. The locking device may further be placed in an area of the rod member covered by the canvas holding the patient, in order to further secure and protect the locking mechanism.

The Locking Devices Between the Longitudinal Rods

In order to keep the longitudinal rods at a lateral distance, and to ensure that the stretcher do not collapse in the lateral direction when in use, the stretcher is fitted with one or more locking devices between the longitudinal rods. In the preferred embodiment there are two lateral locking devices preferably situated towards the end pieces of the longitudinal support rods. The locking devices may also be situated close to the hinges of the longitudinal rods.

These locking devices are preferably fitted on the lower side of the canvas carrying the patient and consist of two rod elements each linked to a respective longitudinal support rod and also interlinked together. The links to the support rods are preferably of a hinge type enabling the locking device rods to be swung in the longitudinal direction of the stretcher. As the two locking device rods are also interlinked with a hinge type link element, the locking device may be folded when the stretcher is folded in the lateral direction. This provides a possibility to fold the stretcher and also acts to spread the stretcher in the lateral direction when preparing for use. Furthermore the interlink between the two locking device rods is fitted with an over-centre lock, i.e. the two locking device rods and the interlink may be placed in an over-centre position and may further be held in place by the securing straps of the harness.

When the locking device rods are being swung into place when preparing the stretcher for use, they will contribute to spread the canvas upon which the patient will be placed and will, when moved to a full spread be moved slightly beyond the full spread after which the over-centre lock will keep the locking device rods in a firm position. The over-centre lock may have several embodiments. In the preferred embodiment the lock is a “stopper” or a plate restricting the movement of the interlink between the two locking device rods. Once the locking device rods are pushed over the linear centre point where the two locking device rods form a linear element, the locking device will keep the longitudinal rods in a firm position. In order for the over-centre lock to be kept in place it will interact in the lateral direction with the canvas in the lateral direction and with the securing straps of the harness in the longitudinal direction.

The Canvas

In order to hold a patient, the stretcher is fitted with a canvas between the longitudinal support rods. The canvas is preferably a textile, enabling the stretcher to be folded. In the preferred embodiment the canvas is further treated with a flame retardant medium for the safety of the patient and in accordance with the aviation requirements. Various other coatings and treatments to ease the cleaning of the stretcher may also be envisaged.

The canvas must be securely fitted to the longitudinal support rods, and in the preferred embodiment of the stretcher the canvas is either fitted with, or formed with longitudinal pockets through which the longitudinal rods are placed on each side of the canvas.

The canvas furthermore has the function of keeping the longitudinal rods at a predetermined lateral distance, limiting the lateral distance in such a way that when the stretcher is unfolded and ready for use, the canvas is taut and the distance between the longitudinal rods is limited so that the locking devices between the longitudinal rods are not allowed to move over center and collapse. The canvas thus interacts with the locking devices between the longitudinal rods.

The canvas is further kept taut in the longitudinal direction by being fastened to the longitudinal rods in the longitudinal direction also preventing the canvas from moving in the longitudinal direction of the support rods e.g. when the patient is carried in steep angles in the longitudinal direction.

The canvas is fastened to the longitudinal rods through pockets or fastening means like rings, mountings or fittings in the canvas, interacting with a hook or similar fastening means on the longitudinal support rods. These fastening means are preferably fitted close to the end pieces of the support rods in order to stretch the canvas as much as possible in the longitudinal direction, yielding a maximum available area of the canvas for carrying the patient and to meet the requirements defined for military field stretchers.

Additionally, at the head end of the stretcher there may be fitted a strap system for securing additional equipment such as a neck/head immobilizer and/or an adjustable back rest for the patient.

The Harness

The harness serves several purposes and contributes to both strength and stability of the stretcher in addition to being an essential part of the stretcher as a load carrying element in the system for transporting the stretcher. As the harness secures the patient to the stretcher, both in longitudinal and lateral direction, the patient and the stretcher may be regarded as one single unit in some respects and the stretcher becomes a part of the patient. This greatly influences the perception of how the patient is treated during transport in the system as described below.

The harness is furthermore attached not only to the canvas but is also attached underneath the canvas in such a way that the harness secures one or more of the lateral locking devices. Thus the harness is an integrated part of the stretcher not only for providing support for the patient but also contributing to the strength and security of the entire construction. As the harness secures one or more of the lateral locking devices, the harness also contributes to securing the stretcher from collapsing in the lateral direction.

This is accomplished by the harness having at least one loop or sling with adjustable length and a buckle or other type of locking mechanism underneath the canvas. The sling may be integrated into the harness in several ways. The loop or sling may be attached to the canvas by stitching, rivets, glue or other fastening means. Preferably the harness securing the patient is also fastened to not only the canvas but also to the harness underneath the canvass securing the lateral locking mechanism. The harness thus secures the patient directly to the lateral locking device and again to the longitudinal support rods.

The harness has means for securing the patient in the lateral direction preferably in the area of the hips/legs. The harness may also have several lateral securing means for the feet and/or abdomen area.

Furthermore the harness has means for securing the patient in the longitudinal direction of the stretcher, preferably in both longitudinal directions. The harness is preferably securing the shoulder area to prevent the patient from sliding off the stretcher in one longitudinal direction and in the groin area. This secures the patient from sliding in the opposite longitudinal direction. The harness is furthermore preferably in one piece securing the patient in both longitudinal directions, or consisting of two interconnected harnesses both attached to the canvas.

When the patient is experiencing severe movement in the longitudinal direction of the stretcher, the harness not only transmits the inherent load to the canvas but also transmits the load exerted by the patient to the lateral locking devices in a direction further preventing these from collapsing, i.e. in the same direction as the over-centre locking function of the lateral locking devices. These lateral locking devices are further attached to the longitudinal rods, in essence securing the patient to all parts of the stretcher construction.

The harness securing the patient in the longitudinal directions and in the lateral directions may also preferably be releasably interconnected.

The harness may be fabricated from web material or similar flexible, preferably non elastic material. The harness may be opened and closed using buckles or similar securing mechanisms.

As the harness secures the patient in both longitudinal and lateral direction, the patient also feels secure, greatly reducing stress which may be of disadvantage to the patient.

The shoulder harness is integrated to the canvas in the hip area and is placed under a transversal strap in the shoulder area. When transporting prune patients the shoulder harness should preferably be placed underneath the transversal strap. If the stretcher is equipped with a suitable back rest, the shoulder harness is pulled out from the transversal strap to secure the patient while sitting on the stretcher.

In total this construction provides a stretcher with unique qualities brought forward by the sum of all constructional features.
The longitudinal supports rods are foldable enabling the stretcher to be foldable for storage and transport. The hinges enabling the longitudinal rods to be foldable are prevented from collapsing in the lateral direction when unfolded due to the construction of the hinges. This maintains the structural integrity in the longitudinal direction.
The lateral locking mechanisms keep the longitudinal support rods spread, interacting with the canvas limiting the lateral spread of the stretcher. The lateral locking mechanisms with the over-centre locking device further prevent the stretcher from collapsing in the lateral direction maintaining the structural integrity of the stretcher in the lateral direction.
The end-pieces are collapsible in the longitudinal direction providing handles for carrying the stretcher and enabling adjustment of the length of the stretcher to fit in various vehicles. This provides flexibility when fitting the stretcher with a patient in a vehicle and reduces the overall length of the stretcher when folded for transport and storage.
The canvas is securely fastened to the longitudinal rods at each end of each of the rods to ensure that the canvas is properly spread in the longitudinal direction. The fastening means are preferably hooks or clamps on the outside of the longitudinal rods so as not to interfere with the extendable end-pieces.
The harness is attached to the canvas and to the longitudinal support rods as well as to the lateral locking devices. This secures the patient to the entire stretcher structure. The harness further secures the patient in both directions of the longitudinal direction of the stretcher in the lateral direction as well as in the vertical direction. As the harness is secured not only to the canvas but to the entire construction, the ability to withstand severe forces and loads for the patient is increased similar to the stretchers ability to withstand such forces.

A stretcher according to the above is envisaged to withstand forces in the longitudinal and vertical direction of up to 9 G. The stretcher is furthermore envisaged to withstand severe G forces in all directions without collapsing and with the patient still securely strapped to the stretcher. Additionally the stretcher is envisaged to meet current NATO standards 2040 and 3204 regarding dimensions and ability to withstand forces.

The System for Transporting a Patient Using a Stretcher as Described

The present invention further pertains to a system for transporting a patient using the stretcher as described above. Particularly the system is designed from the concept of the stretcher and patient being one unit.

The Stretcher During Evacuation

The stretcher may be used for evacuating a patient during combat actions or in civilian life, e.g. from an accident. The key feature of the stretcher is in this case both its ability to be folded and thus easily transported and stored, in addition to its robustness and strength during the actual evacuation by manually carrying the stretcher.

The extendable end-pieces with handles and the harness securing the patient provide an optimal situation for rapid and effective evacuation.

The Stretcher During Transport by Land or Sea

As the construction of the stretcher is also designed to meet the demands for stretchers used in land or sea vehicles, the stretcher may be used during transport without having to move the patient to a different stretcher.

The stretcher may further be attached inside the vehicle by suitable means. These may be shock absorbing devices reducing the vibrations of the vehicle for the safety and comfort of the patient or simply a rack holding several stretchers.

The Stretcher During Transport by Air

When transporting by air the demands for safety are rather strict and patients are often moved onto a bed or stretcher specifically designed for such transport.

When however the stretcher is in itself able to comply with the demands and requirements for such transport and meets the demands for securing the patient, the stretcher may form a part of the transport system in an aircraft, provided that the stretcher may be safely secured to the system.

I.e. the transport system used in the aircraft for transporting a patient does not have a full stretcher system or bed system for the patient, but will interact with the stretcher presented above. Resulting from this the stretcher system onboard the aircraft may be of a simpler construction resulting in reduced weight and cost.

The Total Transport Chain

In total the stretcher according to the present invention may be used for transporting a patient all the way from the accident site to the end facility for treatment without having to move the patient, causing stress and unnecessary discomfort for the patient.

The transport is made simpler by the fact that the stretcher is made into an integrated part with the patient. Furthermore, as the stretcher in the preferred embodiment meets the criteria set forth in the current NATO standards for size and load, any boat or land vehicle meeting the same NATO demands may be transformed into an ambulance when transport by sea or land is required. This is simply done by either unfolding a collapsed rack or attaching supports for the stretcher and the attaching the stretcher to the supports or racks.

This enables any land vehicle or boat to be used, not only ambulances and particular rescue boats, greatly increasing the evacuation capability and capacity. However as regulations and demands for secure transport is strengthened, the stretcher must meet increasingly higher standards when it comes to strength, impact sustainability, securing the patient and so on.

An embodiment of the invention pertaining to the foldable stretcher is further illustrated in the accompanying drawings and described below. Furthermore, various equipment for securing the stretcher during transport in land and sea vessels and airplanes is also illustrated in the accompanying drawings and are more thoroughly described as below.

### BRIEF DESCRIPTION OF THE FIGURES

FIG. 1 illustrates the preferred embodiment of a stretcher according to the present invention.

FIG. 2 illustrates the stretcher in FIG. 1 in side elevation.

FIG. 3 show in perspective the constructional features of the longitudinal rods and the lateral locking devices.

FIGS. 3a and 3b show details of the construction in FIG. 3.

FIG. 4a-c show details of the hinges enabling the longitudinal rods to be foldable.

### DETAILED DESCRIPTION OF THE INVENTION

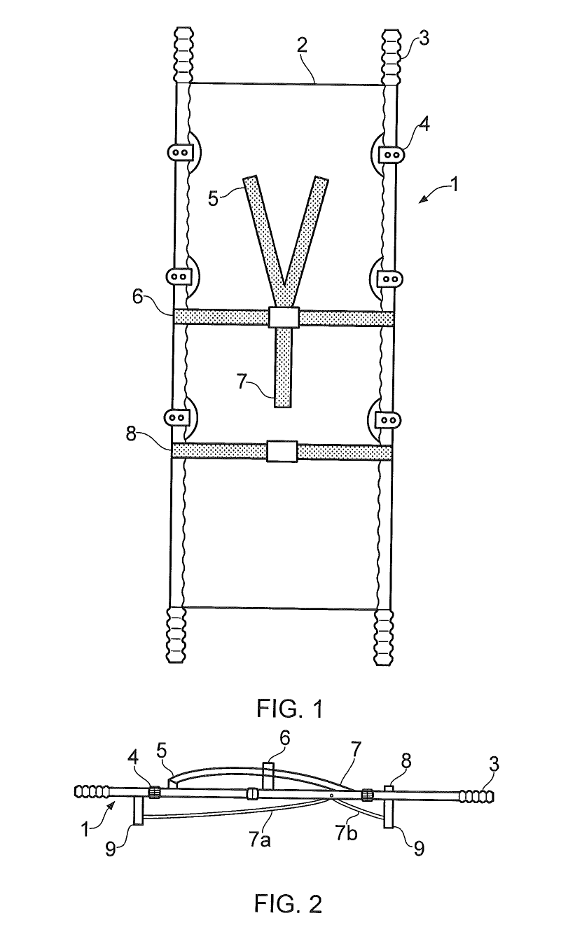

In FIGS. 1 and 2 an embodiment of the stretcher is shown in plan view and side elevation with the longitudinal support rods 1 on each side of the stretcher, covered by the canvas 2. In this embodiment the longitudinal support rods 1 are each made up of four support rod elements interconnected by the hinges 4, folding in the lateral direction of the stretcher. As can be seen from the arrows A and B, the hinges are foldable in different directions along the lateral plane of the stretcher. Furthermore the extendable handles 3 are shown at each end of each of the longitudinal rods 1.

The harness is in FIG. 1 shown with the shoulder straps 5 fastened close to the head end of the stretcher. The straps 5 are further joined close to the waist or hips of the patient, held in place by the lateral strap 6 of the harness. The strap 6 may be attached to the shoulder straps 5 in multiple places in the longitudinal direction of the shoulder straps 5, which allows for adjustable length of the shoulder straps 5 enabling adjustment according to the height of the patient. Furthermore the strap 6 secures the patient in the lateral direction in the waist or hip area.

The lower part of the harness 7a, 7b is further fastened to the canvass close to the groin area 7 of the patient. The fastening in this area is also in FIG. 2 shown as a collective fastening for the parts of the harness underneath the stretcher. When the patient is experiencing forces due to movement, theses forces are not only transmitted through the harness to the canvas and thus to the longitudinal rods, but also further to the lateral locking devices. The harness 7a, 7b underneath the stretcher is shown as two slings with buckles, strapped around the centre piece of the lateral locking devices at each end of the stretcher, preventing these from buckling and thus keeping them locked in place, thus preventing the stretcher from unexpectedly collapsing in the lateral direction and enabling the stretcher to withstand severe forces inflicted on the patient in this direction.

A strap 8 may also be used to further secure the legs of the patient in the lateral direction, also increasing the patient's feeling of being securely strapped to the stretcher and reducing patient stress.

The stretcher is also fitted with legs 9, preferably foldable to ensure minimum size of the stretcher when folded for transport and storage.

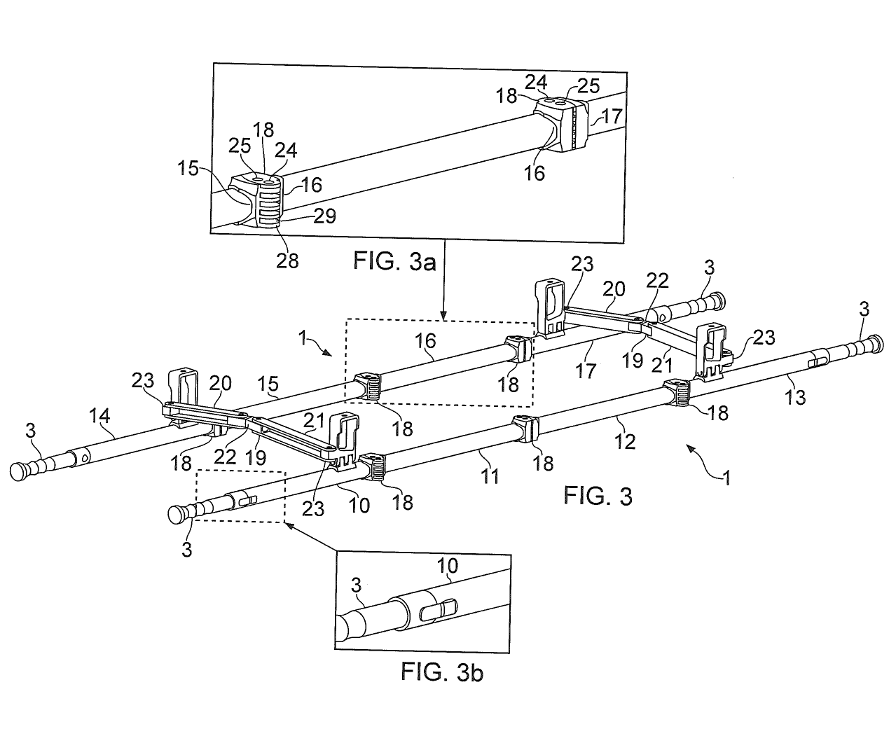

Furthermore, in FIG. 3 an embodiment of the stretcher without the canvas is shown. The longitudinal support rods 1 have four support rod elements 10, 11, 12, 13 and 14, 15, 16, 17. These elements are joined by the hinges 18, equal to the hinges 4 in FIG. 1.

FIG. 3 also shows the handles 3 and FIG. 3b shows details of the releasable locking device 31 attached to the longitudinal support rod element 10, interacting with a slot, groove or hole 31 in the handle 3. Similar locking devices are found on all handles. The locking device 31 may be released by extracting the pin from the slot, groove or hole 30, after which the handle may we extended in the longitudinal direction. A further slot, groove or hole in the extended handle may be used to secure the handle in the extended position. When the stretcher is to be placed inside a vehicle or airplane the handles may be placed back into the support rods if needed by reversing releasing the locking device 31 and pushing the handles back in.

FIG. 3a furthermore shows details of the hinges 18 joining the support rod elements. The hinges are formed by the end pieces of the support rod elements. In FIG. 3a the support rod elements 15 and 16 are joined by a hinge 18 and the support rod element 16 is furthermore joined to the support rod element 17 by a similar hinge 18 folding in the opposite direction.

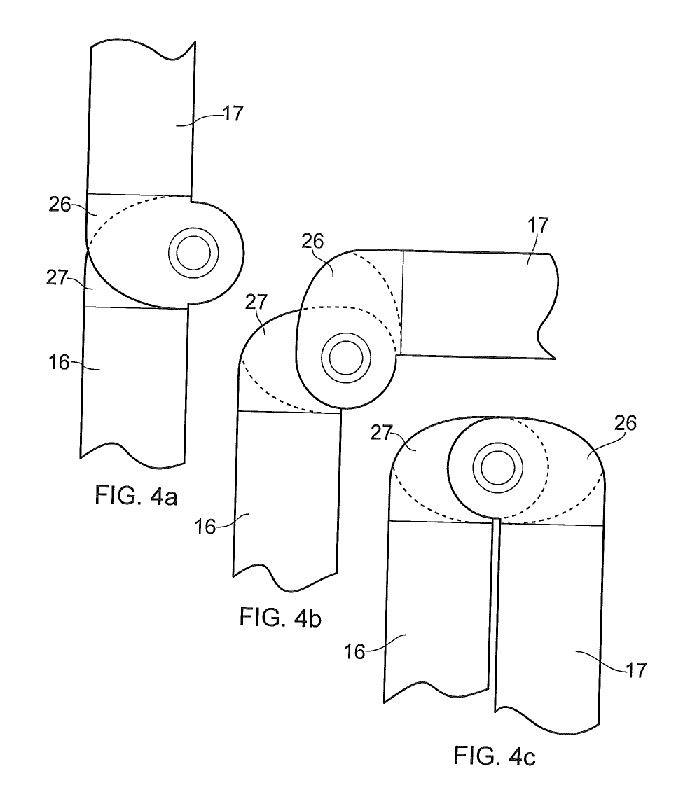

The end pieces (26 and 27 in FIG. 4) of the support rod elements, comprise a set of multiple disks 28 with individual spacing 29. The spacing is substantially equal to or slightly larger than the disks 28, enabling the disks of two end pieces to be interlaced to form a mesh, again forming a hinge. The two sets of disks are locked into place by the pin 24 around which the end pieces revolve. Furthermore a hole 25 is fitted in the centre of the disks 28 of the end pieces, enabling a locking pin to be inserted or any piece of equipment to be placed.

FIG. 3 also shows the foldable legs 9 and the lateral locking devices 19 formed by the lateral locking rods 20, 21 forming a lateral support for the stretcher and locking the longitudinal rods at a preferable distance and forming a stabile stretcher together with the longitudinal rods and the canvas. The maximum width of the stretcher is determined by the width of the canvas and the canvas is kept taut by the lateral locking devices 19. The lateral locking rods 20, 21 are furthermore interlinked by the locking element 22 forming an over centre locking mechanism which again is secured by the lower slings 7a, 7b of the harness. The locking element 22 is shaped so that it allows the rods 20, 21 to be folded towards the proximate end of the longitudinal rods. When folded in the other direction, i.e. towards the centre of the stretcher, the locking element 22 will move into an over centre position locking the rods 20, 21. The harness 7a, 7b in FIG. 2 will further secure the position of the locking devices 22 and prevent them from collapsing.

The lateral locking rods 20, 21 are linked by hinges to the foldable legs 9, again linked to the longitudinal rods 1 by hinges. Alternatively the locking rods 20, 21 may be linked directly to the longitudinal rods 1.

FIGS. 4a to 4c shows a sequence of folding the hinges 18 linking the longitudinal support rod elements. FIG. 4a-4c show the hinge between the support rod elements 16 and 17 as an example.

In FIG. 4a the longitudinal support rod elements 16 and 17 are in line with each other in the longitudinal direction indicating that the stretcher is not folded. The end piece 26 of the rod element 17 and the end piece 27 of the rod element 16 comprise several arc shaped disks with individual spacing, interlaced to form a mesh. The number of disks may be chosen depending on the material used and the expected load, however a minimum may be regarded as one end piece having two disks and the opposite end piece having just one disk. Preferably a number of disks are used to form the hinge. As seen in FIG. 4a the end pieces are held in place, forming a hinge, by the pin 24 around which the end pieces revolve.

In FIG. 4b the rod elements 16 and 17 are at 90° indicating that the stretcher is about to be folded. Furthermore in FIG. 4c the two rod elements 16 and 17 are completely folded.

When the stretcher is to be unfolded the process will be in reverse and as can be seen from FIGS. 4c and 4b the arc shaped elements will not be able to pinch the user or any equipment in the proximity. The arc shaped elements will simply push any interfering elements to the side until the hinge is completely unfolded. This constitutes the pinch free characteristic of the hinges according to the invention.

1. Foldable stretcher for transporting a patient, said stretcher being foldable in both longitudinal and lateral direction, the stretcher comprising two longitudinal support rods (1) with end pieces (3) at each end, wherein the support rods (1) comprise a plurality of longitudinal support segments (10, 11, 12, 13, 14, 15, 16, 17) individually linked by hinges (4, 18), which hinges (4, 18) are foldable substantially in the lateral direction of the stretcher when unfolded, and said stretcher further comprising one or more foldable lateral locking devices (19) between the longitudinal supports (1), which lateral locking devices (19), when extended, spread the longitudinal supports (1) to each side, and which lateral locking devices (19) are foldable in the longitudinal direction of the unfolded stretcher, said stretcher yet further comprising a canvas (2) upon which the patient will rest, which canvas is attached to the longitudinal support rods (1) and the canvas (2) is fitted with a first attachment arrangement for firmly attaching the canvas (2) at least to each of the outermost longitudinal support segments (10, 13, 14, 17) of the longitudinal support rods (1), which outermost segments (10, 13, 14, 17) of the longitudinal support rods (1) are fitted with a second attachment arrangement for firmly attaching to the first attachment arrangement of the canvas, and the stretcher is fitted with a harness (5, 6, 7, 7a, 7b), which harness (5) is attached to the canvas (2) in the shoulder area of the patient placed on the stretcher, and which harness (7) is attached to the canvas (2) in the groin area of a patient placed on the stretcher, and which harness (6) is attached on each side of the stretcher, and which harness has adjustable harness elements (7a, 7b) underneath the canvas (2), which adjustable harness elements (7a, 7b) are connected to the lateral locking devices (19) when the stretcher is unfolded.

2. Foldable stretcher according to claim 1, wherein the hinges (18) fold in alternating opposite directions.

3. Foldable stretcher according to claim 2, wherein the outermost hinges (18) on each longitudinal support rod (1) fold in the same direction in order for the end-pieces (3) of the stretcher to be facing in the same direction when the stretcher is folded.

4. Foldable stretcher according to claim 1, wherein the hinge (18) comprises two separate hinge elements (26, 27), forming the end piece of the individual longitudinal support members, which hinge elements (26, 27) revolve around a common pin (25), enabling the hinge to fold the longitudinal support rods in the lateral direction of the stretcher when unfolded.

5. Foldable stretcher according to claim 4, wherein the hinges (18) comprises two 90° arc shaped hinge elements (26, 27) each consisting of a number of discs (28) individually spaced apart which discs extend in the lateral direction of the stretcher when unfolded which spacing (29) between the disks has substantially the same dimension as the thickness of the disks (28) on the opposite hinge element thus enabling the disks (28) on each hinge element (26, 27) to form a mesh.

6. Foldable stretcher according to claim 5, wherein the hinge elements (26, 27) revolve on a common pin (25) perpendicular to the disks (28) and the arch shaped disks (28) thus form a hinge in which the pin (25) is situated to one side of the disks (28), forming an ex-center point of rotation.

7. Foldable stretcher according to claim 1, wherein the lateral locking devices (19) each comprise two or more lateral locking device rods (20, 21) each linked to the respective longitudinal support rod by hinges (23) and are interlinked by a hinge, (22)

8. Foldable stretcher according to claim 7, wherein the link means (23) forming a link to the support rods (1) are of a hinge type enabling the locking device rods (20, 21) to be swung in the longitudinal direction of the stretcher.

9. Foldable stretcher according to claim 8, wherein the interlink means (22) comprises a hinge type link element with an over-centre lock.

10. Foldable stretcher according to claim 1, wherein the canvas (2) is kept taut in the longitudinal direction by being fastened to the longitudinal rods (1) in the longitudinal direction through fastening means like rings, mountings or fittings in the canvas, interacting with a hook or similar fastening means attached to the longitudinal support rods.

11. Foldable stretcher according to claim 1, wherein the canvas has open channels in the longitudinal direction in which the longitudinal supports (1) are extending.

12. Foldable stretcher according to claim 1, wherein the harness has at least one adjustable harness element (7a, 7b) in the form of a loop or sling with adjustable length and a buckle or other type of locking mechanism underneath the canvas, which is connected around the lateral locking device, keeping this in a the over-centre position when the stretcher is unfolded.

13. Foldable stretcher according to claim 12, wherein the harness elements (7a, 7b) arc attached to the canvas by stitching, rivets, glue or other fastening means.

14. Foldable stretcher according to claim 12, wherein the harness has means attached to each side of the stretcher, being fastened across the stretcher for securing the patient in the lateral direction preferably in the area of the hips/legs.

15. Foldable stretcher according to claim 12, wherein the harness has means attached to each side of the stretcher, being fastened across the stretcher in the lateral direction for securing the feet and/or abdomen area of the patient.

16. Foldable stretcher according to claim 12, wherein the harness has restraining means patient in the longitudinal direction of the stretcher which restraining means are attached to the canvas (2) in the shoulder area of the stretcher and to the groin area, which harness is fitted with an adjustment device for adjusting the length according to the size of the patient and which adjustment device is fitted with at least one locking device for securely fastening the patient in the longitudinal direction.

17. System for transporting a patient in a land or sea vessel or airplane comprising a foldable stretcher according to claim 1-16, and means arranged in the vessel or airplane for releasably attaching the stretcher with the patient to a rack or support.
